(19) United States
(12) Patent Application Publication
(10) Pub. No.: US 2010/0042685 A1
(43) Pub. Date: Feb. 18, 2010

(54) PERSONALIZING COMMUNICATIONS LAYER

(75) Inventors: Avida Yanovski, Yavne (IL); Tal Meller, Ness Ziona (IL)

Correspondence Address: YORAM TSIVION, P.O. BOX 1307, PARDES HANNA, 37111, IL

(73) Assignee: NOVOCORE LTD., Ness Ziona (IL)

(21) Appl. No.: 12/297,315

(22) PCT Filed: Apr. 5, 2007
(86) PCT No.: PCT/IB2007/051233

§ 371 Date: Oct. 16, 2008

Related U.S. Application Data
(60) Provisional application No. 60/744,942, filed on Apr. 17, 2006.
(60) Provisional application No. 60/888,090, filed on Feb. 4, 2007.

(51) Int. Cl. G06F 15/16; G06F 15/173

(52) U.S. Cl. 709/205; 709/224

(57) ABSTRACT

A system implementing the present invention uses client/server architecture enabling remote access and personalization in accessing internet sites. In accordance with the present invention a user is equipped with a software enabled device (SED) that is also web enabled. A SED includes a client platform which includes a translator application that translates URLs to a local pseudo-name and vice versa, i.e. translates a local pseudo-name to URL. The client platform further includes a uniquely configured and designed GUI and a mechanism for implementing an online community of users visiting the same website. In another aspect of the present invention, a management layer is constructed that furnishes the subscribing user with a personalized routing mechanism navigate quickly in familiarized portions of the WWW.

### FIELD OF THE INVENTION

The present invention is in the field of internet and cellular networks. More specifically, the invention is concerned with the access to the World Wide Web (WWW) from a device having access to the WWW.

### BACKGROUND OF THE INVENTION

The Internet was initially developed by U.S universities and DARPA for the purpose of exchanging information and data between end points using packet switched networks. The internet is now widely used by anyone who wishes to search for information, to exchange information, to communicate and to buy or sell almost anything using the virtual web.

The Internet is based on a huge number of web servers which are located all over the world and connected by virtual net, connecting increasing number of computers worldwide, hence the name: World Wide Web (WWW). The web server is constantly logged on to the net and supplies services to the users using web pages. A web site is basically one or more interlinked logically related web pages. A web site contains one or more topics. A web page is a file that is written or translated to hypertext mark-up language (HTML) which is a standard file format that is manifested as a human interface.

Each web page has a Uniform Resource Locator (URL). When a user types the specific URL on the web browser, one of the many servers of the internet automatically directs the user to the designated web page and then loads and displays the web page associated with the URL. A URL is basically the internet's means to create an address for a web page. For example, the URL for the American news broadcasting network CNN, is “http://www.cnn.com”.

As mentioned above, one of the main purposes for using the internet is to find information. However, the internet today contains hundreds of millions of web sites. This creates a problem for the information seeking user. The user must input the precise URL, or otherwise, he would not be able get the desired information. To overcome this problem, the browser concept was developed. The browser is an internet system that allows the user to reach the information he seeks by scanning very quickly the hundreds of millions of web pages and presenting the search result as a list of URLs that contains the web pages supposedly containing the information the user seeks. However, in spite of the employment of the browser, the rapid growth of the content on the internet still creates a growing problem that only increases with time. It is assumed that the ability of the user to find information and navigate through the web will diminish in years to come.

Due to the fact that finding relevant information remains a problem, other methods of finding information and web pages were developed. A user can find the URLs he seeks and keep them in his “favorites” list. The “favorites” system is stored in the pc and displayed on the internet toolbar. The list of favorites can be updated at the will of the user such as by adding a selected web page to a list to enable to upload a specific web page very easily in the future. All the user need to do upon locating a needed web page is to enter the favorites tool bar and click “Add to favorites”. The designated URL will be automatically saved in the user's personal favorites list. The use of the favorites tool has become very popular as many internet users have created their own favorites list on their personal computer. That list represents user's interest area.

However, the favorites doesn't completely solve the problem of finding the information, as it lacks the ability to expose the user to the variety of different web sites the user had never seen before but may be interested in. The favorites function also cannot help the Internet user with the need to type the URL (for example: “http://www.cnn.com”) for the first time. That presents a problem to many internet users that do not remember the specific URL, or do not know English very well, or even misprinted the URL in the exact sequence of words, dots etc. The enormous variety of URLs with similar spelling makes this problem even bigger.

The cellular phone technology known as WAP for 2.5G and 3G allows the user to access the Internet using the personal cell phone. The navigation through the internet web pages with the cell phone based on the current browsing methods is difficult due to the fact that the cellular phone's interface is small and requires time and skill to print the correct URL.

The current method of browsing has created a “one way road” of information between the internet user and the creators of the information. Currently the user receives the information from the URL in many cases without the awareness of the information creator. Some URLs request or even require the personal identification of the user in some cases even as a condition for the accessibility to the information but this practice is very uncommon as it contradicts the free spirit of the web and the natural tendency of most users not to expose their personal details in the web.

Numbers represent abstract ideas and universal concepts. The numerals 0-9 are located in the keypad on the keyboard of every computer as well as many other devices such Cell-phones, PDA, etc.

The “up” and “down” keys are also located on the keyboard of every computer, cell phone and PDA. These buttons allow the user to navigate within systems such as “office”, “windows” and the internet explorer. They are easy to remember and operate.

It is the purpose of the present invention to utilize numbers as a universal language and the “up” and “down” arrows located on the keyboard to navigate in the world wide web, 2.5G and 3G cellular phones, and other devices such as PDAs, to expand the channels of communication between users, information provides and creators and to add new platforms and uses to the web. The current situation limits the ability of the information creators to receive feedback from the information users easily while respecting the user's privacy.

### BRIEF DESCRIPTION OF THE DRAWINGS

FIG. 1 is a schematic description of a GUI configured in accordance with the present invention;

FIG. 2 is a schematic description of a personal management layer in accordance with present invention;

FIG. 3 is a schematic description of personalizing manager architecture and its interaction with end points and the Internet, in accordance with the preferred embodiment of the present invention;

FIG. 4A is a flow chart describing uploading procedure from SED to PM of content URL and its associated pseudo-name;

FIG. 4B is a flow chart describing uploading procedure from SED to PM of WEB content, content URL and its associated pseudo-name;

FIG. 5 is an example describing the procedure of receiving a feedback channel.

### DETAILED DESCRIPTION OF THE PRESENT INVENTION

The present application claims priority from U.S. provisional patent application Ser. No. 60/744,942, filed Apr. 17, 2006, entitled, “BROWSING AND CHAT SYSTEM USING NUMERICAL DEFINITION” and from U.S. provisional patent application Ser. No. 60/596,465, filed Feb. 4, 2007, entitled “PERSONALIZING COMMUNICATIONS LAYER”.

A system implementing the present invention uses client/server architecture enabling remote access and personalization in accessing Internet sites. In according with the present invention a user is equipped with a software enabled device that is also web enabled. Such a device is referred to hereinafter as SED, which is for example a 3G cellular phone, TV, personal computer (PC), laptop and personal digital assistant (PDA). A SED includes a client platform that is implemented in accordance with the present invention. The client platform includes a translator application that translates URLs to a local pseudo-name and vice versa, i.e. translates a local pseudo-name to URL. The client platform further includes a uniquely configured and designed GUI and a mechanism for implementing an online community of users visiting the same website. An online community is a grouping of people, having some common interest, that can communicate and interact via the internet. Examples of applications for implementing such interaction are chats, talkbacks, forums and video messages.

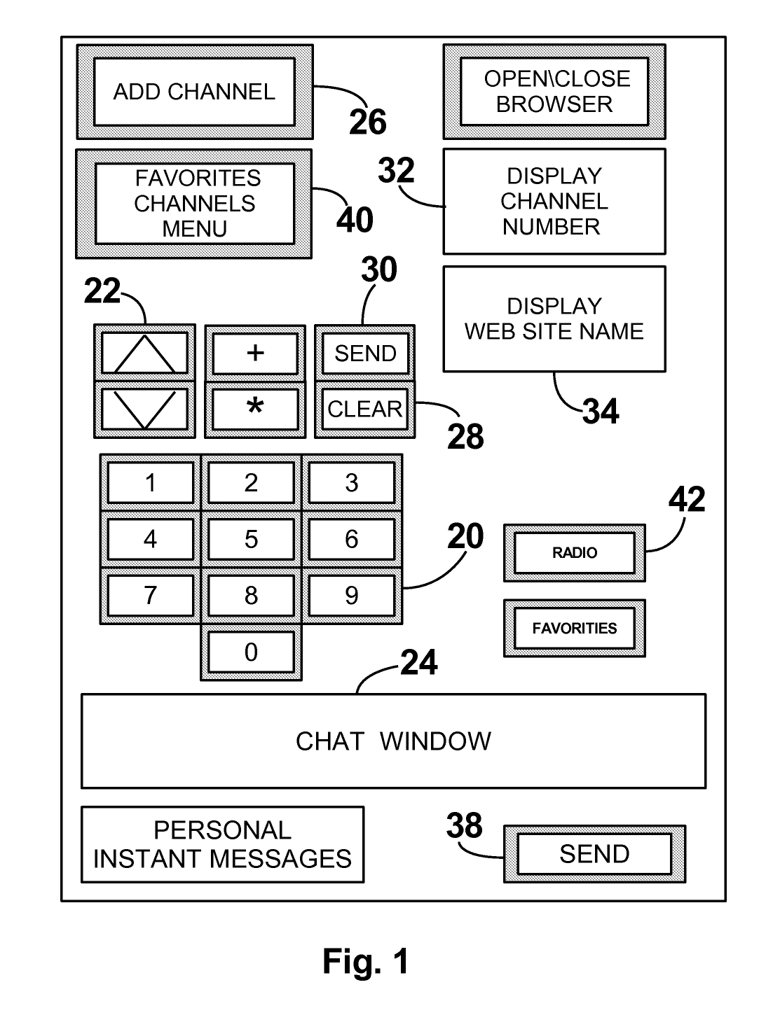

An example of a GUI configured in accordance with the present invention is described schematically in FIG. 1 to which reference is now made. The GUI employs several features and components such as:
0-9 numeric keypad 20
“Up”/“Down” buttons 22
chat window 24
channel adding button 26
channels menu of favorite channels
clear button 28
send button 30
display of channel number currently visited 32
display of web page name currently visited 34

The system client platform includes two modes of navigation: “Quick-Dial” and “Zapping” explanations of which follow:
“Quick-Dial”—this mode is for quick browsing, allowing instant access to favorites' sites. For example, the client platform translates URLs of user favorite sites to pseudo names. The user can navigate to one of his favorites' sites by typing the relevant pseudo name.
“Zapping”—by clicking on the Up/Down buttons the user can browse the predefined pseudo names of his favorite web sites. These predefined pseudo names can be categorized in a menu. For example pseudo names of web sites that are related to sports and pseudo names of web sites that are related to shops are stored in “sport” and “shops” menu categories respectively.

The “Add channel” button allows the user to add a web site link to the client platform. After clicking the “Add channel” button, the client platform GUI asks the user to enter a pseudo-name for the newly added URL. Until the user decides otherwise, the pseudo-name is associated with the added URL.

The client platform further includes a chat application that is displayed in the GUI and enables chat with other users that are currently visiting a same webpage and have a client platform installed in theirs' SEDs.

The chat application is accomplished as follows:
a user writes a message and than presses the “send” button 38
the message is sent to the web site through ISP server (not shown)
the web site receives the message together with the specific URL of the web site which the user is visiting and the rules of distribution defined by the sending user (Such as “All”, “Friends” etc.).
the message is then sent to every user currently visiting that same web site which complies with the rules of distribution

“Favorites channels menu” 40 button executes a function that displays the user favorite channels that he pre-set. “Radio” 42 button directs the user to channels that contain web sites broadcasting radio channels.

“Clear” button 28 deletes the pseudo-name that was pressed before. The “clear” button allows the user to renew the channel number he desires.

“Send” 38 button initiates the procedure opening a web site after the user typed the pseudo-name of channel he desires. After pressing the “Send” button, the chosen web site is uploaded.

### The Personal Management Layer (PML)

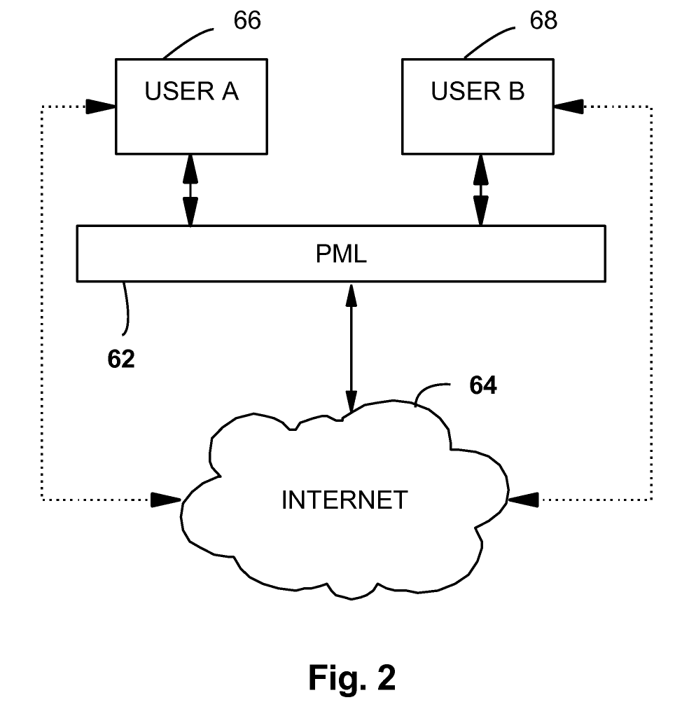

In another aspect of the present invention, a management layer is constructed that furnishes the subscribing user with a personalized routing mechanism to navigate quickly in familiarized portions of the WWW. This is schematically shown in FIG. 2 to which reference is now made. Personal management layer (PML) 62 is located logically between Internet 64 and the users, such as user 66 and 68. The PML has a few functions and they are as follows: 1. it learns the surfing performance of the subscribed user, 2. it creates a personal identity for a user vis-a-vis the internet, 3. it creates feedback channel to the user, and it facilitates the forming of user communities. This however does not preclude the direct access of the users to the internet as hereinto fore practiced.

The system in accordance with the present invention provides each user with a personal pseudo-name analogous to a host name or a numeric IP address. An example for such a useful numerical domain can be the phone number of a user. This feature supports the Web 2.0 which is the reference for the second generation of Internet-based services—such as social networking sites, wikis, communication tools, and folksonomies—that emphasize online collaboration and sharing among users.

### The Personalizing Manager

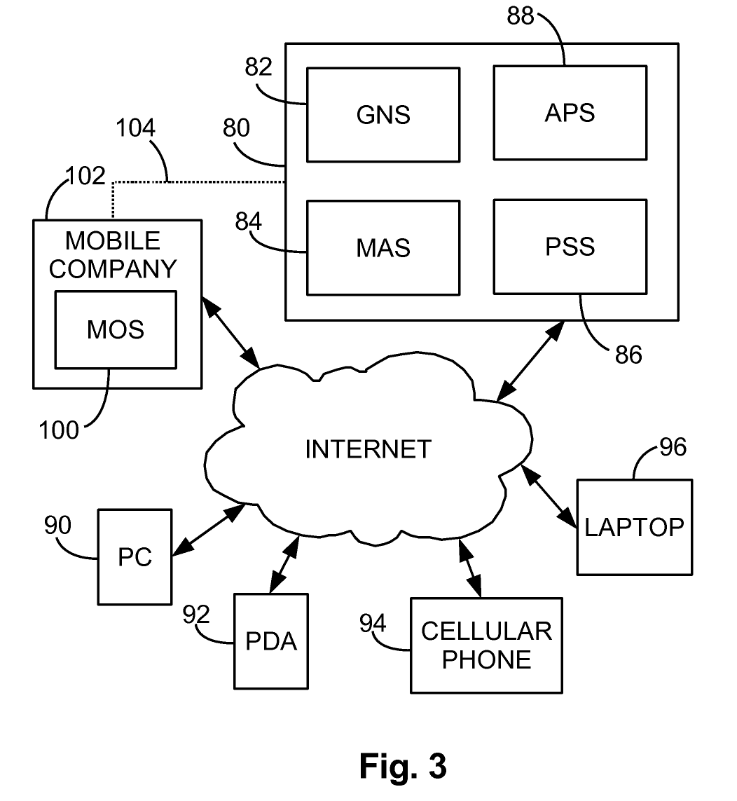

The architecture of the personalizing manager (PM) and its interaction with end points and the Internet in accordance with the preferred embodiment of the present invention is described in FIG. 3 to which reference is now made. PM 80 includes general pseudo-number server (GNS) 82, management server (MAS) 84, personal storage server (PSS) 86 and application server (APS) 88. GNS 82 stores and handles the URLs and its associate pseudo-name. For example the GNS stores and handles the pseudo-name and personal URL of a user. In another example, a personalized user web page and an electronic business card. PSS 86 stores data that is accumulated from users for example the user favorites URLs and the corresponding pseudo-names. In one embodiment of the present invention the PSS stores user data as a semantic data base (SDM). SDM is a flexible database management system that stores the meanings of information as facts about objects. For example, PSS stores links of users' favorite's web sites, pseudo-names, links and pseudo-names of his friends these contents and other complementary content provide such data base. Management server (MAS) 84 is responsible for managing the aforementioned servers, for example the MAS identifies the web-site that the user is surfing and also identifies requests of the user, and accordingly sends him an appropriate application such as a chat application. APS 88 handles the applications that interact with the online community. In accordance with an embodiment of the present invention, the PM further includes a mobile server 100 referred to hereinafter as MOS which is located in cellular facility 102. The MOS stores all or part of the data that relate to a user and that are stored in the GNS and PSS servers. The MOS is further synchronized with these servers indicated in FIG. 3 with dashed line 104. In the content of the present invention the synchronization is in the sense of continuous update the data stored in the MOS with a part or all of the data stored in GNS 82 and PSS 86 servers. The SED such as PC 90, PDA 92 cellular phone 94 and laptop 96 are each equipped with a client platform implemented in accordance with the present invention.

### Downloading and Uploading Mechanism

The system in accordance with a preferred embodiment of the present invention further includes a dynamic personalized webpage for a user. The personal webpage and its contents are stored in the PSS and the MOS. The personalized webpage is used for organizing and accessing personalized contents. For example, links for favorite web-sites, personal e-business cards and other users. Personal e-business cards include web-site links to private community and photo sharing web sites such as www.myspace.com and www.flickr.com. A default personal webpage can be offered to the user which can include for example a list of useful popular sites, organized by categories. A user can edit a personal webpage, add categories and sites and assign or change pseudo name to be associated with each URL according to personal preferences.

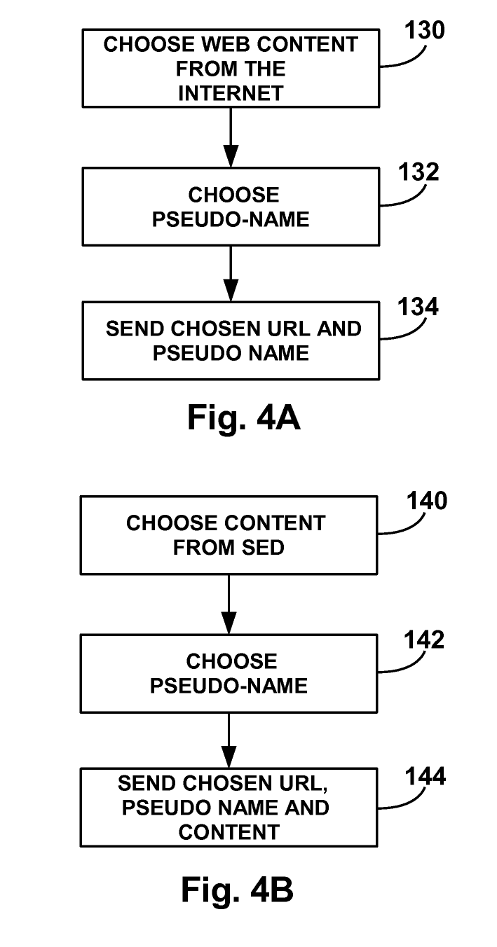

The system according to the present invention provides the user with the ability to download or upload content from/to the PSS and MOS. The uploading procedure is described by a flow chart in FIGS. 4A-B to which reference is now made. A user surfing the internet via SED equipped with the client platform is depicted. Referring to FIG. 4A in step 130 the user chooses web content such as picture, movie and audio files. The choice can be made by manually pointing at the relevant content with a mouse cursor and by clicking on the mouse button, an application window is opened guiding the user, as to how and where to store the chosen contents. In step 132 the user chooses a personal pseudo name for the chosen content. In step 134 the user sends on the internet the URL and the associated pseudo name of the chosen content to be stored in the PML. Referring to FIG. 4B, an uploading procedure of user's personal content such as picture, movie and audio files is described. In step 140 a user chooses content which is stored in his SED. In step 142 the user chooses a personal pseudo name for the chosen content. In step 144 the user sends on the internet the URL, the associated pseudo name and the chosen content to be stored in the PM. In order to download content from PM, the user sends to PM via his SED the desired pseudo-name of the content. In response to the user request the PM sends the content to SED. In cases wherein the SED is a cellular phone, the SED optionally, can download/upload content or links to content from/to MOS.

### The Feedback Channel Content

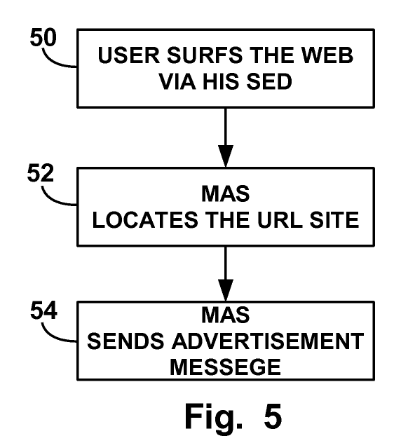

The PM enables a feedback channel between the user and the owner of the information without violating the privacy of the user or his right to remain anonymous. An example describing the procedure of receiving the feedback channel is described by a flowchart in FIG. 5 to which reference is now made. In step 50 the user surf to a web site via his client platform that is installed in his SED; the website URL is stored in PM. In step 52 the MAS locates the URL site. In step 54 MAS sends any kind of message such as an advertisement. The advertisement message can be for example an advertisement related to a web that a user is currently surfing, it could be an advertisement that is related to the user surfing habits, and it can be also an advertisement related to the user skin. Skins are custom graphical appearances (GUIs) that can be applied to certain software and websites in order to suit the different tastes of different users.

### User Privacy

In another aspect of the present invention a user can surf to a website anonymously, i.e. the website will not receive information about the user and user surfing habits for example by cookies. Cookies are text files that are stored at the client's hard drive. Cookies are commonly used to rotate the banner ads that a site sends so that it does not keep sending the same ad as it sends to a surfer a succession of requested pages. They can also be used to customize pages for a surfer based on his browser type or other information a surfer may have provided the web site.

The user chooses with a SED the site which he wants to surf; the PM receives his request and connects him with the web site. The web site can not spy on the user because the site does not know that the user has visited the website.

The feed back channels to the user can be private in respect to the web site he currently surfing, i.e. the feedback channels are sent from PM and not from the website. In another aspect of the present invention a user can deactivate his client platform if he does not want that the PM will send him feed channels or spy on his surfing habits.

Examples of the chat/collaboration, reversed channel, anonymous navigation and channel navigation (“zapping”) scenarios are described next.

### Example 1

### Chat/Collaboration Scenario

A user surfs to a site or to a page in a site. The user can look for other users currently surfing in the same site or page in the site. The user can then chat or collaborate with his ad-hoc peers.

In order to employ this scenario, the user first installs a client platform in his SED. The user surfs to a website or page in a website. The client application monitors the user's browser for its location in the World Wide Web through the browser application programming interface (API). The client application notifies the PM (typically the MAS) regarding the user location by use of a web service such as SOAP. SOAP is a simple XML-based protocol to allow for applications to exchange information over HTTP. A user can check the APS for other users through for example an ad-hoc chat room window in the client application. This information is transferred through TCP on a special designated socket. A socket is one endpoint of a two-way communication link between two programs running on the network. A socket is bound to a port number so that the TCP layer can identify the application that data is destined to be sent. Using the chat application the user can chat/collaborate in compliance with the TCP.

### Example 2

### Feedback Channel Scenario

A user surfs to a web site. The user can receive messages such as an advertisement through the feedback channel. The information is tailored to the user characteristics and behavior. In such a scenario the user first installs the client platform, and then surfs to a web site or page. The user client application monitors the user browser for its location through the browser API. The client application notifies the PM (Typically the MAS) with regard to the user location by using a web service such as SOAP protocol. In the next step, the APS checks the PSS for the user's previous surfing behavior and information tags. The APS sends relevant messages such as advertisements or other information that relates to the user's surfing habits to the user through the chat TCP socket connection.

### Example 3

### Anonymous Navigation

A user client platform is installed in a user's SED, the client application of a user is not running, the user clicks on a channel number in his graphic user interface (GUI) or enters an URL in his SED browser. When other users who use their browsers navigate to this URL, the user is anonymous in respect to the other users i.e. other users that surf in the same location of the user can not monitor the user because the user is linked to the web site through the MAS.

### Example 4

### Channel Navigation “Zapping”

A user installs a client platform. The user's client application stores and updates the channel repository from/to the GNS and uses a web service such as SOAP protocol to communicate with the MAS. The user content links are stored in the PSS. The user selects a pseudo-name of a channel which is translated into an URL. The client application use the browser's API to make the user's browser navigates to that URL.

1. A method for implementing a management layer over the internet, said method comprising:
installing a client platform on a software enabled device (SED) with a connection to the internet;
connecting said SED through the internet to a personalizing manager (PM) and interacting with said PM;
learning the surfing performance of the subscribed user;
creating a personal identity for a user vis a vis the Internet, and
creating a feedback channel to said user.

2. A method for implementing a management layer over the internet as in claim 1, wherein data sent to a user through said feedback channel are dependent on the user semantic database.

3. A method for implementing a management layer over the internet as in claim 1, wherein said method further comprises synchronizing data between a general pseudo-number server (GNS), a personal storage server and a mobile server (MOS).

4. A method for implementing a management layer over the internet as in claim 1, wherein said method further keeping user privacy when surfing on a web site by connecting to the web site through the MAS.

5. A method for implementing a management layer over the internet as in claim 1, wherein said interaction between SED and PM further comprises translating URL to a local pseudo-name and vice versa

6. A system for implementing a management layer over the internet, said system comprising:
software enabled device (SED);
client platform installed in said SED;
general pseudo-number server (GNS) for storing and translating pseudo-name to URL and vice versa;
a personal storage server (PSS) for storing user content links and files;
an application server (APS) for handling an applications that interacts with users;
management server (MAS) for managing said servers.

7. A system for implementing a management layer over the internet as in claim 6, wherein said PSS is a semantic data base (SDM).

8. A system for implementing a management layer over the internet as in claim 6, wherein said management layer further comprises a mobile server (MOS).

9. A system for implementing a management layer over the internet as in claim 6, wherein said client platform comprises a translator application that translates URLs to a local pseudo-name and vice versa.

10. A system for implementing a management layer over the internet as in claim 6, wherein said client platform comprising a means for implementing an online community of users visiting same website.

11. A system for implementing a management layer over the internet as in claim 6, wherein said client platform is installed in a mobile phone, and wherein a mobile company using a MOS sends an SMS message containing a URL.
